(19) United States
(12) Patent Application Publication
(10) Pub. No.: US 2026/0246007 A1
(43) Pub. Date: Aug. 20, 2026

(54) TEMPERATURE CONTROL PLATE FOR CONNECTION WITH A BATTERY HOUSING, BATTERY HOUSING FOR A MOTOR VEHICLE, AND METHOD FOR MANUFACTURING A BATTERY HOUSING

(71) Applicant: BENTELER AUTOMOBILTECHNIK GMBH, Paderborn (DE)

(72) Inventors: Conrad FRISCHKORN, Paderborn (DE); Christian BUSE, Lichtenau (DE); Karoline KAESEWIETER, Paderborn (DE)

(21) Appl. No.: 19/537,492

(22) Filed: Feb. 12, 2026

(30) Foreign Application Priority Data
Feb. 14, 2025 (EP) 25157904.1

(51) Int. Cl. H01M 10/625; H01M 10/613; H01M 10/6556; H01M 50/224; H01M 50/231; H01M 50/238; H01M 50/242; H01M 50/249

(52) U.S. Cl. CPC H01M 10/625; H01M 10/613; H01M 10/6556; H01M 50/224; H01M 50/231; H01M 50/238; H01M 50/242; H01M 50/249; H01M 2220/20

(57) ABSTRACT

A temperature control plate for connection with a battery housing of a motor vehicle, including a temperature control duct structure with at least one temperature control duct profile. The temperature control plate is made of a manganese-boron steel sheet and is hot-formed. The temperature control plate has an aluminum alloy layer on the outside. The temperature control plate has a tensile strength Rm>1,000 MPa and a martensitic structure of at least 50 vol. % martensite. A battery housing including a temperature control plate and a method for manufacturing a corresponding battery housing are also described.

### RELATED APPLICATIONS

The present application claims priority of European Application Number 25157904.1 filed Feb. 14, 2025, the disclosure of which is hereby incorporated by reference herein in its entirety.

### FIELD

The present disclosure relates to a temperature control plate for connection with a battery housing of a motor vehicle. The disclosure further relates to a corresponding battery housing for a motor vehicle, and a method for manufacturing such housing.

### BACKGROUND

Electrically powered motor vehicles have a battery housing in which the battery packs required for propulsion are arranged. The battery housing serves two purposes: first, to protect the battery packs, and second, to integrate them into the vehicle structure.

In order to dissipate the heat generated by the battery packs during operation of the motor vehicle, the battery housings are provided with cooling devices. One option is to connect an additional cooling plate to the battery housing. Corresponding cooling plates have temperature control duct profiles which form temperature control ducts when connected to the bottoms of the battery housings. A fluid which removes heat from the battery housing is able to be guided through these temperature control ducts. The cooling plates are able to be connected to the bottom of the battery housing both inside and outside. Corresponding cooling plates are made of a soft aluminum alloy to save weight. If the cooling plates are attached to the outside of the battery housing, a separate underride guard is usually required, otherwise there is a risk of damage to the cooling plates. However, cooling plates made of soft aluminum alloys that are coupled to the bottom on the inside pose a disadvantage for attaching the battery housing to the vehicle. The soft aluminum alloys limit the possible clamping forces, since the cooling plates are able to deform under excessive mechanical stress.

Another concept for cooling the battery housing involves forming temperature control duct profiles which are integrated in the bottom of the battery housing itself and of a uniform material, and placing a cover plate over the temperature control duct profiles so that temperature control ducts are formed again between the temperature control duct profiles and the cover plate. However, integrating the temperature control duct profiles directly into the bottom of the battery housing are able to be disadvantageous with respect to the design freedom of the temperature control duct structure.

### SUMMARY

The object of the present disclosure is to demonstrate an improved temperature control plate that is more resistant to external stresses. Furthermore, the object of the disclosure is to provide a battery housing which has a corresponding temperature control plate. Another object of the present disclosure is to demonstrate a method for manufacturing a corresponding battery housing.

The first part of the object is achieved by a temperature control plate for connection with a battery housing of a motor vehicle having the features defined in claim 1. The second part of the object is achieved by a battery housing for a motor vehicle having the features defined in claim 11. The method part of the object is achieved by a method for producing a battery housing according to the features defined in claim 18.

The present disclosure relates to a temperature control plate for connection with a battery housing of a motor vehicle, an electric vehicle. The temperature control plate has a temperature control duct structure with at least one temperature control duct profile for forming temperature control ducts. The temperature control plate thus has a flat base plate in which at least one temperature control duct profile is formed. The at least one temperature control duct profile is a duct-shaped or trough-shaped stamping, resulting in a recess in the base plate, which has a trapezoidal cross-section.

The temperature control plate is made from a manganese-boron (MnB) steel sheet. MnB steels are high-strength steels that exhibit excellent temperability. According to the present disclosure, the temperature control plate is hot-formed. This means that the MnB steel sheet is first heated, to its austenitizing temperature, then formed and subsequently quenched to obtain the temperature control plate. The strength of the temperature control plate can be further increased by hot forming. The temperature control duct structure is introduced into the MnB steel sheet during the hot forming process, by a pressing process.

According to the present disclosure, the temperature control plate has an outer aluminum alloy layer. The aluminum alloy layer is formed by a precoating applied to the MnB steel sheet prior to hot forming. The precoating has the following composition in addition to aluminum and unavoidable impurities:
5.9 wt. % to 12.9 wt. % Si (silicon),
0.5 wt. % to 4.0 wt. % Fe (iron).

The aluminum precoating can be applied to one or both sides of the MnB steel sheet. Applying the precoating before hot forming has the advantage that the MnB steel sheet is protected from oxidation and scaling and decarburization is prevented. The aluminum alloy layer includes multiple phases or sub-layers, each with different concentrations of Al, Si, and Fe, wherein Al and Si come from the precoating and Fe mainly originates from the MnB steel sheet in addition to the components in the precoating. The aluminum alloy layer is formed during hot forming, during heating in an oven to austenitizing temperature and the associated dwelling phase in the oven under a dry air atmosphere. Besides nitrogen and unavoidable trace gases, the atmosphere predominantly contains 20 to 22 wt % oxygen. The aluminum alloy layer improves the weldability of the hot-formed temperature control plate, since it is a thin, diffusion-hardened protective layer. Furthermore, the aluminum alloy layer provides good protection against rust and corrosion after hot forming. Therefore, applying an additional corrosion protection layer after forming is not absolutely necessary.

Due to the manufacturing process according to the present disclosure, the temperature control plate has a tensile strength Rm greater than 1,000 MPa, greater than 1,300 MPa, and a martensitic structure including of at least 50 vol. % martensite, at least 80 vol. % martensite. However, the tensile strength Rm should not exceed 2000 MPa, since tensile strengths above this limit offer little further potential for lightweight construction but are disadvantageous with respect to elongation at break and ductility properties, in a crash scenario. In comparison to temperature control plates known in the prior art, those made of soft aluminum alloys, the temperature control plate according to the present disclosureis thus significantly more resistant to pressure loads, from the temperature control fluid system itself and other occurring stresses, in crash and run-over events of the motor vehicle.

In at least one embodiment of the present disclosure, the MnB steel is one of the steel types or steel alloys A to F, the compositions of which are given in wt. % in the table inserted below. Entries that refer to another element, for example steel type D under Cr max “0.5—Mo,” are to be interpreted in such a way that the respective value of the specified element from the corresponding column of the table is to be subtracted from the listed numerical value.

| | C | | Si | | Mn | | P | S | Al | | B | | Cr | |
|---|---|---|---|---|---|---|---|---|---|---|---|---|---|---|
| | min | max | min | max | min | max | max | max | min | max | min | max | min | max |
| Steel A | 0.19 | 0.25 | 0.1 | 0.4 | 1.1 | 1.4 | 0.02 | 0.01 | 0 | 0.06 | 0.004 | 0.1 | | 0.3 |
| Steel B | 0.20 | 0.23 | 0.2 | 0.3 | 1.1 | 1.4 | 0.02 | 0.01 | 0 | 0.06 | 0.004 | 0.1 | 0.1 | 0.3 |
| Steel C | 0.31 | 0.37 | 0.1 | 0.6 | 1 | 1.5 | 0.03 | 0.02 | | 0.1 | 0.001 | 0.004 | 0.08 | 0.35 |
| Steel D | 0.33 | 0.35 | 0.15 | 0.35 | 1 | 1.5 | 0.03 | 0.02 | 0.01 | 0.08 | 0.001 | 0.004 | 0.08 | 0.5-Mo |
| Steel E | 0.08 | 0.13 | | 0.7 | 0.8 | 1.9 | 0.05 | 0.05 | | 0.1 | 0.001 | 0.003 | | 0.15 |
| Steel F | 0.09 | 0.12 | 0.02 | 0.6 | 1.2 | 1.8 | 0.03 | 0.01 | 0.01 | 0.07 | 0.0007 | 0.002 | | 0.15 |

| | Cu | N | Nb | | Ni | | Ti | | V | Mo |
|---|---|---|---|---|---|---|---|---|---|---|
| | max | max | min | max | min | max | min | max | max | max |
| Steel A | 0.1 | | | 0.05-Ti | 0 | 0.1 | 0.01 | 0.1 | | 0.35 |
| Steel B | 0.1 | 0.01 | | 0.05-Ti | 0 | 0.1 | 0.02 | 0.05 | 0.01 | 0.35 |
| Steel C | 0.2 | 0.2 | | 0.1 | | 0.2 | 0.002 | 0.05 | | 0.35 |
| Steel D | 0.2 | 0.2 | 0 | 0.06 | | 0.2 | 0.005 | 0.02 | 0.01 | 0.5-Cr |
| Steel E | 0.2 | 0.2 | | 0.1 | | | | 1.2 | 0.1 | 0.1 |
| Steel F | 0.2 | 0.2 | 0 | 0.1 | | | 0.03 | 0.2 | 0.1 | 0.1 |

Steel types A and B may be 22MnB5 steel. Steel type C may be a 34MnB5 steel. Steel type D may be a 37MnB5 steel. Steel types E and F may be the Ductibor 1000 steel type. These types of steel have proven advantageous within the scope of the present disclosure due to their high-strength properties.

In at least one embodiment of the present disclosure, the temperature control duct profile has a meandering and/or multiply branching serpentine shape. In the context of the present disclosure, meandering means that the temperature control duct profile has a regular curved loop or S-shaped profile. In comparison, the temperature control duct profile can also have irregular profile in a serpentine design. The meandering and/or serpentine design of the temperature control duct profile ensures uniform cooling or heating of the batteries that are in direct or indirect contact with the temperature control plate. Furthermore, appropriate gradients allow for the largest possible area of the temperature control plate to be provided with corresponding temperature control duct profiles.

In at least one embodiment of the present disclosure, 70% to 90%, 70% to 80% of the surface of the temperature control plate has corresponding temperature control duct profiles.

In at least one embodiment of the present disclosure, the temperature control duct profiles are embossed into the temperature control plate such that two temperature control duct profiles are parallel to each other. Thus, two temperature control duct profiles run parallel to each other across the temperature control plate. This further increases the effective temperature control capacity. However, in accordance with the present disclosure, the temperature control duct structure can also be configured in such a way that a temperature control duct profile is distributed across the temperature control plate.

Within the scope of the present disclosure, it has also proven advantageous if the temperature control plate has a sheet thickness of 0.5 mm to 2.0 mm, of 0.7 mm to 1.5 mm. A suitable sheet thickness offers an advantageous compromise between stability and weight of the temperature control plate.

The aluminum alloy layer has a layer thickness of 7 μm to 50 μm, of 10 μm to 44 μm, and of 12 to 40 μm. The layer thickness refers to the sum of all sub-layers of the outer aluminum alloy layer.

A stiffening projection can be formed between adjacent temperature control duct profiles or temperature control duct profile sections. The stability of the temperature control plate can be further increased by means of appropriate stiffening projections, such that it simultaneously fulfills an underride protection function when connected externally to the bottom of a battery housing.

In at least one embodiment of the present disclosure, at least one bead is arranged in the temperature control duct profile. The bead is arranged in a bend or turn of the temperature control duct profile. The effective diameter of the temperature control duct formed by the temperature control duct profile is widened in the bends, especially if these bends have a tight corner radius. The additional bead ensures that the cross-sectional area through which the temperature control fluid flows is kept at a similar level. At the same time, the additional bead itself can be curved in its course in the longitudinal direction of the temperature control duct. The curvature then occurs in the direction of the bend or turn of the temperature control duct profile. This results in flow control or flow guidance.

In at least one embodiment of the present disclosure, the temperature control duct profile has a height of 2 mm to 15 mm, a height of 3 mm to 12 mm, and most a height of 4 mm to 10 mm. This height interval has proven to be advantageous within the scope of the present disclosure, since the temperature control duct profiles do not project too far from the vehicle towards the ground, when the temperature control plate is arranged below the battery housing of a motor vehicle. At the same time, the resulting cross-sectional area of the temperature control duct profile is dimensioned according to the present disclosure such that sufficient temperature control capacity is ensured by the fluid flowing through the temperature control duct profiles.

In at least one embodiment of the present disclosure, the width of the temperature control profile is between 30 and 70 mm, between 40 and 60 mm, and about 50 mm.

The temperature control plate has at least one through-opening, wherein the through opening is arranged between two adjacent temperature control duct profiles or temperature control duct profile sections. The temperature control plate can be attached to the frame structure of a motor vehicle together with the battery housing, optionally via the through opening.

In at least one embodiment of the present disclosure, the temperature control plate is press-hardened to increase its hardness and resistance to stress.

The present disclosure further relates to a battery housing for a motor vehicle, an electric vehicle. The present disclosure therefore also relates to an electric vehicle having a battery housing or an electric vehicle battery housing. The battery housing has a bottom and at least four side walls connected to the bottom, which together form an interior space for receiving or covering traction batteries. The bottom and the side walls connected to the bottom form a battery tray, wherein the battery tray can function both as a hood, that is, a cover, and as a tray. If the battery tray is used as a tray, the opening of the interior faces upwards, that is, towards an underside of the vehicle. If, however, the battery tray is used as a hood, the opening of the battery tray points downwards, away from the vehicle floor.

The battery housing includes a temperature control plate according to any one of claims 1 to 10. According to the present disclosure, there are two ways in which the temperature control plate is integrated into the battery housing.

In a first variant, the temperature control plate is connected in a fluid-tight manner to the bottom of the battery tray by means of laser welding or gluing. Due to the fluid-tight connection between the temperature control plate and the bottom, which is flat, the bottom forms temperature control ducts with the temperature control duct profiles. A fluid can be passed through the temperature control ducts, which fluid can be used for cooling the batteries located inside the battery housing. However, it is also possible to use the temperature control fluid to heat the batteries inside the battery housing.

In the second alternative, the temperature control plate is laser-welded or glued in a fluid-tight manner to a lid of the battery housing. The lid is positioned opposite the bottom of the battery tray and thus covers the interior of the battery tray. The lid is also configured to be flat. Temperature control ducts through which the temperature control fluid can be guided are formed between the lid and the temperature control duct profiles.

In both coupling variants according to the present disclosure, the temperature control plate can be connected to the bottom or lid on the inside or outside. Inside means that the temperature control plate is located within the interior space defined by the bottom and the side walls. External means that the temperature control plate is not located inside the battery tray, but is connected to the bottom or the lid outside the interior.

The battery tray, which has a bottom and at least four side walls, can be formed in one piece. In at least one embodiment of the present disclosure, the battery tray is made of a sheet of steel, for example an MnB steel sheet, which has been formed into a battery tray, by cold forming. Alternatively, the bottom and at least four side walls can also be cut from a sheet of steel and then joined together to form the battery tray, by welding.

In at least one embodiment of the present disclosure, the bottom and/or side walls are made of a precoated sheet steel, wherein the precoating can be an Al—Si precoating or a Zn precoating. The precoating serves primarily to protect the battery tray from corrosion.

Reinforcing profiles are arranged outside the interior on opposite side walls of the battery housing. The reinforcing profiles protrude beyond the temperature control ducts when viewed from the vehicle, in the vertical direction of the vehicle. The reinforcing profiles can improve the stiffness and crash properties of the battery housing.

In at least one embodiment of the present disclosure, the temperature control plate is welded to the bottom or lid all the way around its outer edges. In at least one embodiment of the present disclosure, it is laser-welded to the bottom or the lid using a fillet weld. This ensures a secure and fluid-tight connection between the temperature control plate and the bottom or lid. In at least one embodiment of the present disclosure, the weld seam engages a maximum of 90%, and a maximum of 80%, of the thickness of the bottom or the lid. This prevents leaks of the required welding bath supports.

The method according to the present disclosure for manufacturing a battery housing for a motor vehicle, a battery housing according to any one of claims 11 to 17, includes the following method steps:
providing an MnB steel sheet and subsequently precoating at least one side of the MnB steel sheet, wherein the precoating has the following composition, in addition to Al (aluminum) and unavoidable impurities:
5.9 wt. % to 12.9 wt. % Si (silicon),
0.5 wt. % to 4.0 wt. % Fe (iron).

Subsequent hot forming of the MnB steel sheet into a temperature control plate with a temperature control duct structure that has at least one temperature control duct profile.
providing at least one second sheet of steel, made of MnB steel, and subsequently forming the second sheet of steel into a battery tray with a bottom and four side walls. Alternatively, at least the second sheet of steel can be cut to form a bottom and four side walls, possibly reshaped, and then the bottom and the four side walls can be joined to form a battery tray. It is also conceivable that multiple steel sheets are provided for cutting, such that the bottom and the side walls are cut from different types of steel. According to the present disclosure, the battery tray can therefore be manufactured either in one piece by forming or from separate cut parts by joining.
fluid-tight welding, laser welding, of the temperature control plate to the bottom of the battery tray to obtain the battery housing, or
providing a lid of steel, then welding the temperature control plate to the lid and arranging the lid on an opening in the battery tray to obtain the battery housing.

According to the present disclosure, the temperature control plate can thus be connected to the bottom of the battery housing tray or to the lid of the battery housing. The temperature control plate can be connected to the bottom or to the lid from the inside or the outside.

### BRIEF DESCRIPTION OF THE DRAWINGS

Further advantages, features, and properties of the present invention are the subject matter of the following description. It shows examples of embodiments of the present disclosure and serves to facilitate its understanding. The figures are merely schematic diagrams intended to illustrate the basic structure and function of the present disclosure. The individual embodiments can be combined with each other as desired without departing from the scope of the present disclosure. In the figures:

FIG. 1 shows a perspective view of a temperature control plate according to at least one embodiment,

FIG. 2 shows a perspective view of a first embodiment variant of a battery housing,

FIG. 3 shows a view from below of a second embodiment variant of a battery housing,

FIG. 4A shows the second embodiment variant of the battery housing along the section line A-A from FIG. 3,

FIG. 4B shows the first embodiment variant of the battery housing along the section line B-B from FIG. 2,

FIG. 5A to FIG. 5C show longitudinal sectional views of possible embodiment variants of the battery housing,

FIG. 6A to FIG. 6D show longitudinal sectional views of possible embodiment variants of the battery housing,

FIG. 7A to FIG. 7C show longitudinal sectional views of possible embodiment variants of the battery housing,

FIG. 8A to FIG. 8C show a method for manufacturing a first embodiment variant of the battery housing, and

FIG. 9A to FIG. 9C show a method for manufacturing a second embodiment variant of the battery housing.

### DETAILED DESCRIPTION

In the figures, the same reference numerals are used for same or corresponding components, although a repeated description is omitted to keep things simple.

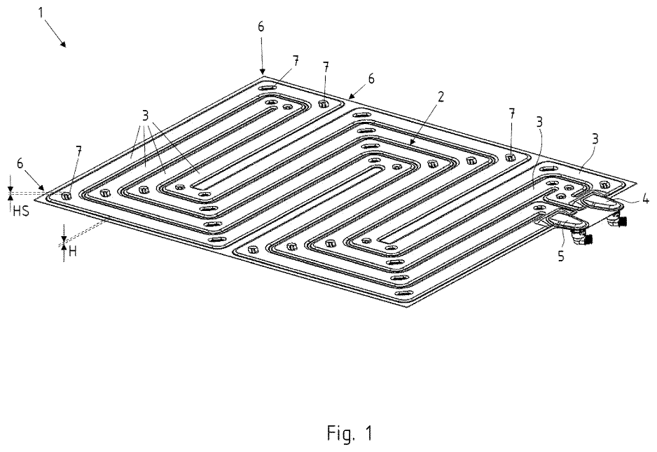

FIG. 1 shows the perspective view of a temperature control plate 1 according to the invention for connection with a battery housing of a motor vehicle, which housing is not shown in detail. The temperature control plate 1 has a temperature control duct structure 2 which is formed from temperature control duct profiles 3. The temperature control duct profiles 3 run in a meandering pattern, thus alternating in parallel rows over the temperature control plate 1. The temperature control plate 1 has an inlet nozzle 4 and an outlet nozzle 5, each of which transitions into the temperature control duct profiles 3. The inlet nozzle 4 is connected to two separate temperature control duct profiles 3, which run adjacent to each other across the entire cooling plate 1 and open into the outlet nozzle 5.

The temperature control plate 1 is made and hot formed from an MnB steel sheet. The temperature control duct profiles 3 are formed in one piece from the MnB steel sheet using a press tool during the hot forming process.

The MnB steel sheet has a precoating prior to hot forming, wherein the precoating contains 5.9 to 12.9 wt. % Si and 0.5 to 4.0 wt. % Fe in addition to aluminum and unavoidable impurities. By means of hot forming, an aluminum alloy layer is formed on the outside of the temperature control plate 1 from the precoating. The temperature control plate 1 further has a tensile strength Rm greater than 1,000 MPa, greater than 1,300 MPa, and a martensitic structure includes at least 50 vol. % martensite, at least 80 vol. % martensite. The temperature control plate 1 according to the present disclosure thus has a significantly increased hardness or strength compared to temperature control plates known in the prior art, so that this plate can be attached to the bottom of a battery housing of a motor vehicle without additional protective devices. If the temperature control plate 1 inside the battery housing is connected to a bottom or a lid of the battery housing that contacts the batteries, its high hardness or strength reduces the risk of damage to the temperature control plate 1 due to clamping forces occurring when screwing the batteries together.

The temperature control duct profiles 3 have a height H of 2 mm to 15 mm. By using a suitable height and relatively wide duct cross-sections, a sufficient cross-sectional area can be achieved within the temperature control duct profile without excessively increasing the overall height of the temperature control plate 1.

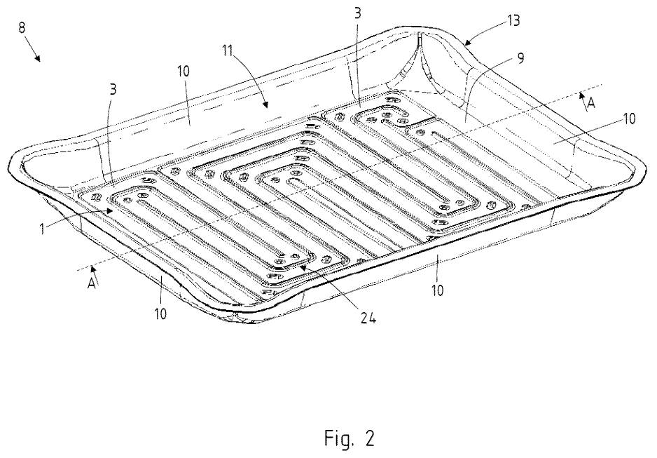

Optionally, beads 7 are arranged in the bends 6 of the temperature control duct profiles 3. The height HS of the beads 7 corresponds to the height H of the temperature control duct profiles 3. Due to the beads 7, the effective flow cross-sectional area of the temperature control duct profiles 3 remains approximately constant even in the bends 6. This ensures a uniform flow of the temperature control fluid within the temperature control duct profiles 3 and avoids reduced cooling performance in the bends due to an additional turbulence effect. FIG. 2 shows a perspective view of a first embodiment variant of a battery housing 8 according to the present disclosure for a motor vehicle not shown in detail. The battery housing 8 has a bottom 9 and four side walls 10 connected to the bottom 9. The bottom 9 and the side walls 10 together form a one-piece battery tray 13 made of a single material and together enclose an interior space 11 for receiving or covering batteries not shown in detail.

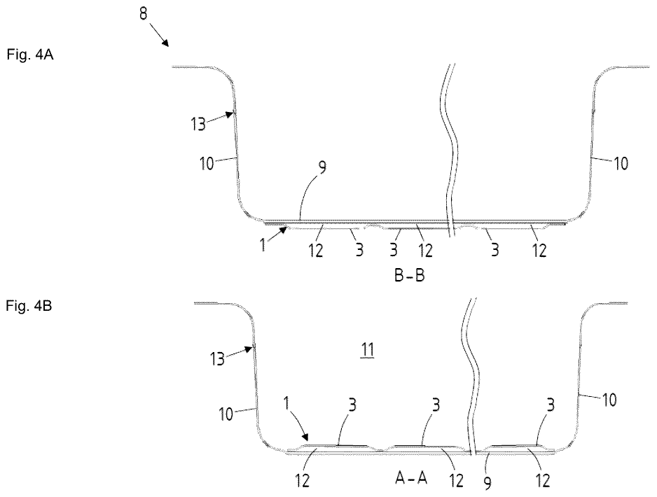

According to the present disclosure, the temperature control plate 1 is connected in a fluid-tight manner to the bottom 9 by means of laser welding or gluing. This is done in such a way that temperature control ducts 12 are formed between the temperature control duct profiles 3 of the temperature control duct structure 2 and the bottom 9. This is shown in FIG. 4B, where the first embodiment variant of the battery housing 8 shown in FIG. 2 is shown in section A-A. FIG. 4B does not show the entire section A-A, but only the end areas adjacent to the side walls 10. For the sake of simplicity, the rear side wall 10 as well as the lid and the batteries contacting the bottom 9 are not shown.

In the first exemplary embodiment shown in FIG. 2 and FIG. 4B, the temperature control plate 1 is connected to the bottom 9 on the inside. Inside means that the temperature control plate 1 is arranged within the interior space 11 defined by the bottom and the side walls.

This has the advantage that the high-strength temperature control duct profiles 3 are not deformed by their own weight or by screwing the batteries together. However, this embodiment variant has the disadvantage that the outer bottom 9 of the battery tray 13, if it is made of a less strong steel, is susceptible to mechanical damage, for example from stone chips or being run over.

The temperature control plate 1 is welded to the bottom 9 between adjacent temperature control duct profiles 3 or temperature control duct profile sections thereof. This can be done by means of a spot weld or a through weld. The welds (24) are continuous and fluid-tight and can be seen in FIG. 2 as respective outer black lines of the duct profiles 3.

The temperature control duct profiles 3 and thus also the temperature control ducts 12 are trapezoidal in cross-section in the exemplary embodiments shown in FIG. 4A and FIG. 4B.

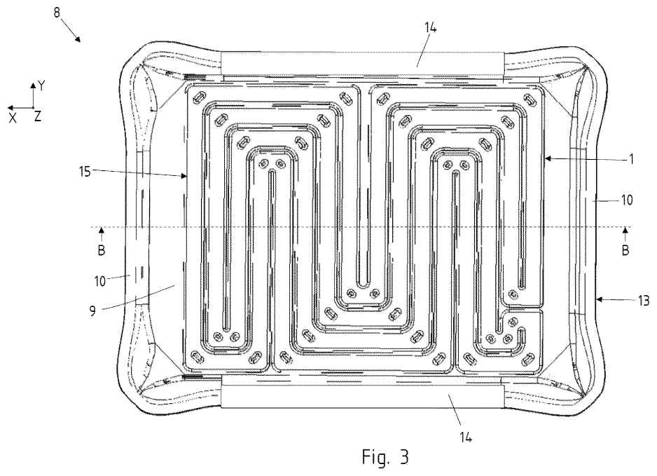

FIG. 3 shows a view from below of a second embodiment variant of a battery housing 8. In contrast to the first embodiment variant, the temperature control plate 1 is connected to the outside of the bottom 9 of the battery tray 13 in the second exemplary embodiment shown here. This is also shown in FIG. 4A, which shows the battery housing 8 in section B-B of FIG. 3. The outside mounting of the temperature control plate 1 on the bottom 9 has the advantage that the interior space 11 is not restricted by the temperature control plate 1 and thus more space is available for accommodating or covering the battery modules. In addition, a completely flat bottom 9 can be provided for optimal battery contact and thus best heat conduction, with the interposition of thermally conductive films, layers or mats. Due to the design of the temperature control plate 1 according to the present disclosure, no additional underbody protection is necessary, since the temperature control plate 1 is very resistant to loads.

FIG. 3 also shows that the battery housing 8 has two reinforcing profiles 14 which are arranged outside the interior space 11 on opposite side walls 10, in this case on the opposite longitudinal sides. The reinforcing profiles 14 can optionally project beyond the temperature control ducts 12 in the vertical direction Z of the motor vehicle when viewed from the motor vehicle. The reinforcing profiles 14 can increase the stability of the battery housing 8. Furthermore, improved crash performance can be achieved. The reinforcing profiles 14 also serve to connect the battery housing 13 to vehicle structures such as sills or ladder frames. If the reinforcing profiles 14 project downwards, a sliding function or an anti-slip function can be fulfilled, thus providing underride protection for the temperature control duct structure 2 itself.

The temperature control plate 1 is laser welded all around its outer edges 15 to the bottom 9 of the battery tray 13, i by means of a fillet weld.

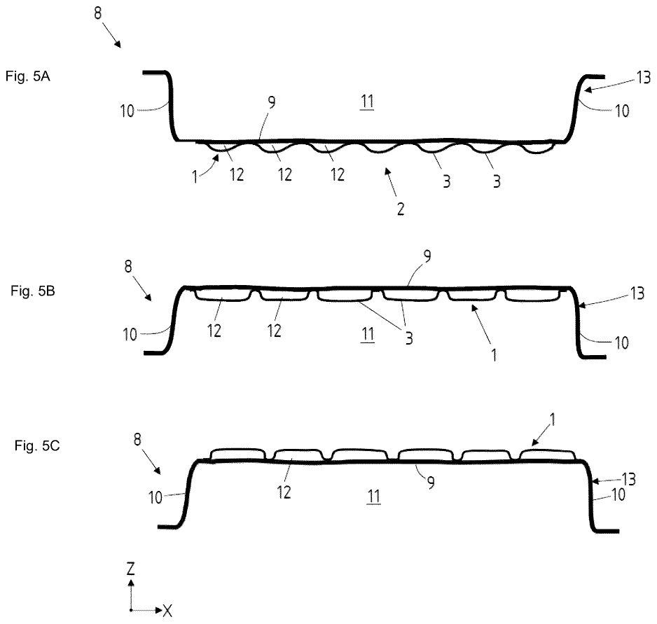

FIG. 5A to FIG. 5C shows longitudinal sectional views of possible embodiment variants of the battery housing 8. The embodiment variant shown in FIG. 5A corresponds in its basic structure to the second embodiment variant shown in FIG. 3 or FIG. 4A, in which the temperature control plate 1 is connected to the bottom 9 of the temperature control plate 1 on the outside, that is, outside the interior space 11. The coordinate system shown in FIG. 5A to FIG. 5C refers to the motor vehicle, wherein the Z axis represents the vertical axis of the motor vehicle and the X axis represents the longitudinal axis of the motor vehicle. The temperature control plate 1 is thus arranged between the ground and the battery tray 13 and therefore also serves as underride protection for the battery tray 13 or the motor vehicle, respectively. The now wave-shaped cross-section of the temperature control duct structure 2 with significantly more individual temperature control ducts 12 offers an even greater stiffness compared to the design variant according to FIG. 2 and FIG. 4A.

FIG. 5B shows that the battery tray 13 can also function as a hood. In this case, the battery tray 13 is connected to the motor vehicle such that the opening of the interior space 11 points downwards, that is, away from the motor vehicle, compared to the embodiment variants shown in FIG. 5A and FIG. 5B. In the exemplary embodiment shown here, the temperature control plate 1 is again joined to the bottom 9 of the battery tray 13 from the interior space 11. The battery tray 13, configured as a hood, can be closed in a fluid-tight manner by means of a lid that can be arranged underneath the tray in the installed position. The batteries are in contact with the temperature control plate 1 on their upper side, for example via an interposed thermal conductivity material.

FIG. 5C shows that the temperature control plate 1 can also be joined to the bottom 9 of the battery tray 13 on the outside when the battery tray 13 is configured as a hood. This has the advantage that the fluid connections are located outside the battery tray 13, such that the temperature control fluid does not enter the interior space 11 of the battery tray 13 in the event of a leak.

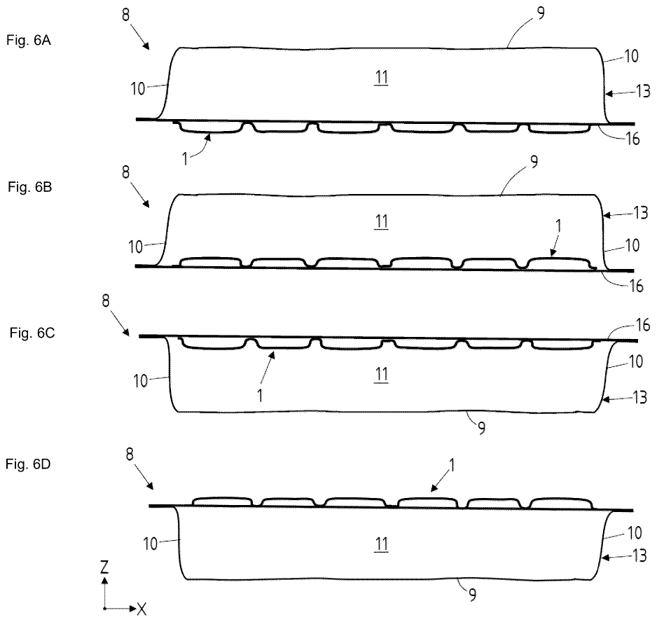

FIG. 6A to FIG. 6D shows further possible embodiment variants of the battery housing 8. In the exemplary embodiments shown here, the battery housing 8 includes a lid 16, which is arranged opposite the bottom 9 and covers the interior space 11 of the battery tray 13. In the exemplary embodiments shown here, the temperature control plates 1 are not connected to the bottom 9 of the battery tray 13 but to the respective lids 16. This increases the design freedom when designing the battery housing 8 for the respective motor vehicle.

In FIG. 6A, the battery tray 13 is configured as a hood, that is, the lid 16 closes off the interior space 11 on the underside of the side of the battery tray 13 facing away from the motor vehicle. The temperature control plate 1 is connected to the lid 16 on the outside, so that the temperature control plate 1 is not located in the interior space 11 of the battery housing.

Alternatively, the temperature control plate 1 can also be connected to the lid 16 on the inside, as shown in FIG. 6B. In this case, the temperature control plate 1 is located in the interior space 11 of the battery housing 8. The advantages are the same as those of the first embodiment variant shown in FIG. 4B.

FIG. 6C shows another embodiment in which the battery tray 13 is configured as a tray. Thus, the lid 16 closes the interior space 11 of the battery tray 13 at the top, that is, on the side of the battery tray 13 facing the vehicle. In this case, the temperature control plate 1 is connected to the inside of the lid 16, such that the temperature control plate 1 is located inside the interior space 11 of the battery housing 8. According to the present disclosure, it is possible for the lid 16 to be an integral part of a body floor panel, thus eliminating the need for a separate lid sheet layer for the battery housing 13. In this case, the lid 16 would continue to the left and right in the image plane and, for example, provide direct connection points above in the direction of the motor vehicle for coupling with the motor vehicle structure, for example a seat cross member. In at least one embodiment of the present disclosure, these connection points can be arranged between two adjacent duct profiles 3 and thus in double-layered flat sections (cover sheet layer and temperature control plate sheet layer).

FIG. 6D shows that the temperature control plate 1 can also be joined to the lid 16 on the outside, i.e. outside the interior space 11, when the battery housing 13 is configured as a tray. In the event of a leak, this ensures that the temperature control fluid cannot penetrate into the interior space 11 of the battery tray 13. In addition, the maximum possible flat contact area to the batteries is increased compared to temperature control plates 1 arranged on the inside.

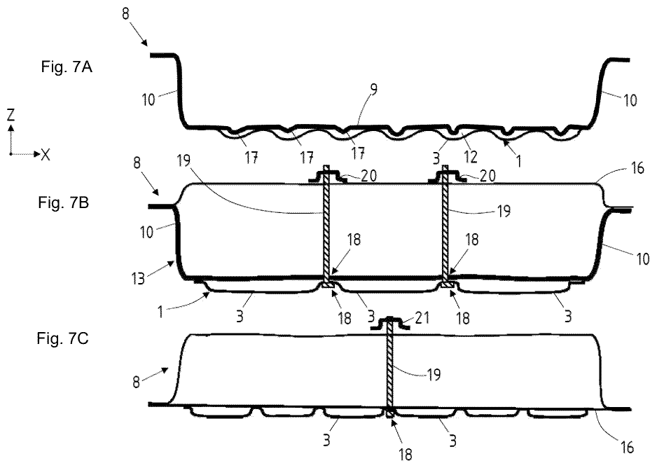

FIG. 7A to FIG. 7C shows further exemplary embodiments of the battery housing 8 according to the present disclosure, each in longitudinal section.

FIG. 7A shows that the bottom 9 of the battery tray 13 can have a plurality of local protrusions 17 which project into the temperature control duct profiles 3 of the temperature control plate 1 and form local turbulators there which can influence the flow within the flow ducts 12 formed between the bottom 9 and the temperature control plate 1.

FIG. 7B shows that both the temperature control plate 1 and the bottom 9 of the battery tray 13 can have through openings 18. The through openings 18 are each arranged between adjacent temperature control duct profiles 3 or between sections thereof. This has the advantage that the through opening 18 does not affect the fluid ducts 12. Fastening elements 19, which couple the battery housing 8, for example, to seat cross members 20 of the motor vehicle, extend through the through openings 18.

FIG. 7C shows an alternative coupling method. In this case, the battery tray 13 is configured as a hood, wherein the temperature control plate 1, the lid 16, and the bottom 9 each have a through opening 18. In this embodiment as well, the through opening 18 of the temperature control plate 1 is located between two adjacent temperature control duct profiles 3 or between sections thereof. The battery housing 8 is in turn connected to a cross member 21 of the motor vehicle using a fastening means 19 extending through the through opening 18.

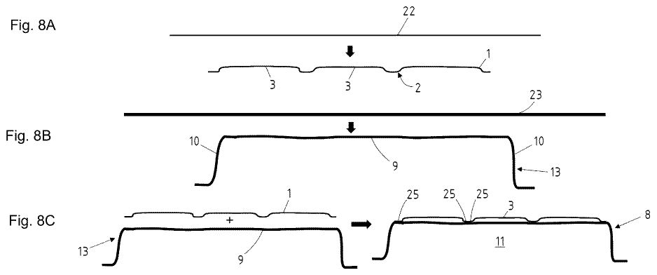

FIG. 8A to FIG. 8C shows the method according to the present disclosure for manufacturing a battery housing 8. According to FIG. 8A, an MnB steel sheet 22 is initially provided which has been covered at least on one side with a precoating containing 5.9 to 12.9 wt. % Si and 0.5 to 4.0 wt. % Fe, in addition to Al and unavoidable impurities. Subsequent hot forming of the MnB steel sheet 22 into a temperature control plate 1 with a temperature control duct profile structure 2 that has at least one temperature control duct profile 3.

Parallel to, upstream or downstream of the method step shown in FIG. 8A, a second steel sheet 23 is provided in a second method step according to FIG. 8B, which may also be an MnB steel sheet. The second steel sheet 23 can also be provided with an Al—Si or a Zn precoating. The second steel sheet 23 is then cold-formed to form a battery tray 13 with a bottom 9 and four side walls 10. Alternatively, at least the second steel sheet 23 can be cut to form a bottom 9 and four side walls 10, and these can then be joined to form a battery tray 13.

In the last method step, which is shown in FIG. 8C, the temperature control plate 1 is fluid-tightly welded to the bottom 9 of the battery tray 13, by means of laser welding, in order to obtain the battery housing 8.

In the method sequence shown in FIG. 8A to FIG. 8C, the temperature control plate 1 is welded to the outside of the battery tray 13. Depending on the number of temperature control duct profiles 3 arranged on the temperature control plate 1 and the resulting distance between the temperature control duct profiles 3, a weld seam 25 or, as shown in this exemplary embodiment, two weld seams 25 can be formed between the temperature control duct profiles 3.

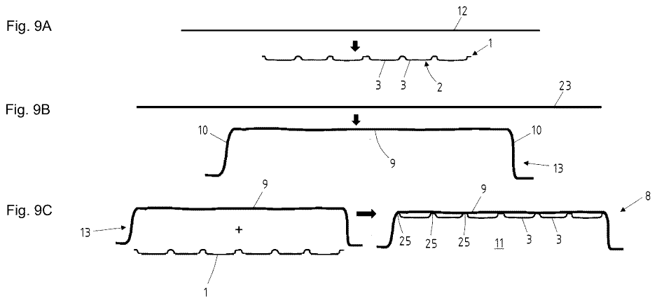

FIG. 9A to FIG. 9C shows an alternative manufacturing method according to the invention for a battery housing 8. The method steps shown in FIG. 9A and FIG. 9B correspond to the method steps according to FIG. 8A and FIG. 8B. In the last method step, which is shown in FIG. 9C, the temperature control plate 1 is welded to the inside of the bottom 9 of the battery tray 13. This means that the temperature control plate 1 is located in the interior space 11 of the battery housing 8. Due to the small distance between the temperature control duct profiles 3, only one weld seam 25 is formed between adjacent temperature control duct profiles 3 in this exemplary embodiment.

1-18. (canceled)

19. A temperature control plate for connection with a battery housing of a motor vehicle, the temperature control plate comprising:
a temperature control duct structure with a temperature control duct profile,
wherein the temperature control plate is comprised of a manganese-boron steel sheet and is hot-formed,
the temperature control plate has an aluminum alloy layer on an outside thereof, and
the temperature control plate has a tensile strength Rm>1,000 MPa and a martensitic structure of at least 50 vol. % martensite.

20. The temperature control plate according to claim 19, wherein a precoating is applied to the manganese-boron steel sheet prior to the hot forming and the precoating has the following composition in addition to aluminum and unavoidable impurities:
5.9 to 12.9 wt. % Si,
0.5 to 4.0 wt. % Fe,
wherein the aluminum alloy layer is formed from the precoating by the hot forming.

21. The temperature control plate according to claim 19, wherein the manganese-boron steel sheet comprises at least the following components:
0.19 to 0.25 wt % C, 1.1 to 1.4 wt % Mn, 0.004 to 0.1 wt % B;
0.2 to 0.23 wt % C, 1.1 to 1.4 wt % Mn, 0.004 to 0.1 wt % B;
0.31 to 0.37 wt % C, 1.1 to 1.5 wt % Mn, 0.001 to 0.004 wt % B;
0.33 to 0.35 wt % C, 1.1 to 1.5 wt % Mn, 0.001 to 0.004 wt % B;
0.08 to 0.13 wt % C, 0.8 to 1.9 wt % Mn, 0.001 to 0.003 wt % B; or
0.09 to 0.12 wt % C, 1.2 to 1.8 wt % Mn, 0.0007 to 0.002 wt % B.

22. The temperature control plate according to claim 19, wherein the temperature control duct profile has a meandering branching course.

23. The temperature control plate according to claim 19, wherein the temperature control plate has a sheet thickness of 0.5 to 2.0 mm.

24. The temperature control plate according to claim 19, wherein the aluminum alloy layer has a layer thickness of 7 μm to 50 μm.

25. The temperature control plate according to claim 19, further comprising a bead arranged in the temperature control duct profile.

26. The temperature control plate according to claim 19, wherein the temperature control duct profile has a tensile strength Rm>1,300 MPa, and the temperature control plate has a martensite structure made of at least 80 vol. % martensite and is press-hardened.

27. The temperature control plate according to claim 19, wherein the temperature control duct profile has a height of 2 mm to 15 mm.

28. The temperature control plate according to claim 19, wherein the temperature control plate has at least one through opening, and the through opening is arranged between two adjacent temperature control duct profiles.

29. A battery housing for a motor vehicle, the battery housing comprising:
a bottom and at least four side walls connected to the bottom to form an interior space configured to receive a battery; and
a temperature control plate comprising a temperature control duct structure with a temperature control duct profile,
wherein the temperature control plate is comprised of a manganese-boron steel sheet and is hot-formed, the temperature control plate has an aluminum alloy layer on an outside thereof, and the temperature control plate has a tensile strength Rm>1,000 MPa and a martensitic structure of at least 50 vol. % martensite, and
wherein the temperature control plate is fluid-tightly connected, by laser welding or gluing, to
a) the bottom in such a way that a temperature control duct is formed between the temperature control duct profile of the temperature control duct structure and the bottom, or
b) a lid of the battery housing in such a way that a temperature control duct is formed between the temperature control duct profile of the temperature control duct structure and the lid, wherein the lid is arranged opposite the bottom and closes off the interior space.

30. The battery housing according to claim 29, wherein the temperature control plate is arranged on a side of the lid or the bottom facing away from the interior space.

31. The battery housing according to claim 29, wherein the bottom and the side walls comprise one piece.

32. The battery housing according to claim 29, wherein the bottom and the side walls are comprised of sheet steel having a precoating, and the precoating is an Al—Si precoating or a Zn precoating.

33. The battery housing according to claim 29, wherein the temperature control plate is welded to the bottom or to the lid between adjacent temperature control duct profiles.

34. The battery housing according to claim 29, further comprising reinforcing profiles arranged outside the interior space on opposite side walls.

35. The battery housing according to claim 29, wherein the temperature control plate is sealed all around via weld along outer edges of the temperature control plate with the bottom or the lid.

36. A method for manufacturing a battery housing for a motor vehicle, the method comprising:
applying a precoating to at least one side of an MnB steel sheet, wherein the precoating has the following composition in addition to aluminum and unavoidable impurities:
5.9 to 12.9 wt. % Si,
0.5 to 4.0 wt. % Fe,
hot forming the MnB steel sheet into a temperature control plate with a temperature control duct structure that has at least one temperature control duct profile;
forming a battery tray having an interior space configured to receive a battery, by
forming a second steel sheet into the battery tray with a bottom and at least four side walls, or
cutting the second steel sheet into a bottom and at least four side walls and subsequent joining to form the battery tray; and
fluid-tightly connecting the temperature control plate to the battery tray, by
welding or gluing the temperature control plate to the bottom of the battery tray to obtain the battery housing in which a temperature control duct is formed between the temperature control duct profile of the temperature control duct structure and the bottom, or
welding the temperature control plate to a lid, and arranging the lid on the battery tray to obtain the battery housing in which a temperature control duct is formed between the temperature control duct profile of the temperature control duct structure and the lid, and the lid is arranged opposite the bottom and closes off the interior space,
wherein the temperature control plate has an aluminum alloy layer on an outside thereof, the aluminum alloy layer is formed from the precoating by the hot forming, and the temperature control plate has a tensile strength Rm>1,000 MPa and a martensitic structure of at least 50 vol. % martensite.

37. The temperature control plate according to claim 19, wherein the temperature control plate has a sheet thickness of 0.7 to 1.5 mm.

38. The temperature control plate according to claim 25, wherein the bead is arranged in a bend of the temperature control duct profile.
